(19) United States
(12) Patent Application Publication
(10) Pub. No.: US 2014/0159886 A1
(43) Pub. Date: Jun. 12, 2014

(54) DRIVING ASSIST DEVICE FOR VEHICLE

(71) Applicants: Naoto Hasegawa, Seto-shi (JP); Shoichi Shono, Miyoshi-shi (JP); Yoshikazu Motozono, Miyoshi-shi (JP); Masao Omura, Miyoshi-shi (JP); Akihiro Ueda, Nagoya-shi (JP); Yasuhiro Tajima, Nisshin-shi (JP); Tomohiro Usami, Toyota-shi (JP); Mitsuhiro Miura, Toyota-shi (JP)

(72) Inventors: Naoto Hasegawa, Seto-shi (JP); Shoichi Shono, Miyoshi-shi (JP); Yoshikazu Motozono, Miyoshi-shi (JP); Masao Omura, Miyoshi-shi (JP); Akihiro Ueda, Nagoya-shi (JP); Yasuhiro Tajima, Nisshin-shi (JP); Tomohiro Usami, Toyota-shi (JP); Mitsuhiro Miura, Toyota-shi (JP)

(73) Assignee: TOYOTA JIDOSHA KABUSHIKI KAISHA, Toyota-shi, Aichi (JP)

(21) Appl. No.: 14/130,753

(22) PCT Filed: Jul. 4, 2011
(86) PCT No.: PCT/JP2011/065302

§ 371 Date: Jan. 3, 2014

(51) Int. Cl. G08G 1/16

(52) U.S. Cl. CPC G08G 1/167
USPC 340/435

(57) ABSTRACT

A vehicle operator assisting apparatus is configured to assist an operator of an own vehicle by displaying an image of a virtual preceding vehicle visually recognizable by the operator as if the virtual preceding vehicle was running in front of said own vehicle in a running state. The assisting apparatus comprises: a history data base storing a driving history of said operator; a virtual preceding vehicle control portion determining a running state of said virtual proceeding vehicle based on said driving history generating portion generating a relationship between a distance between said own vehicle and an actual preceding vehicle, and a running speed of said own vehicle, and storing the relationship in said history database. Said virtual preceding vehicle control portion includes a driving characteristics extracting portion determining a distance between said own vehicle and said virtual preceding vehicle based on said relationship.

### TECHNICAL FIELD

The present invention relates to a technique for assisting an operator of a vehicle in driving the vehicle, by displaying a virtual preceding vehicle.

### BACKGROUND ART

There is known a vehicle operator assisting apparatus arranged to display an image of a virtual preceding vehicle such that the image is visually recognizable by an operator of an own vehicle. Patent Document 1 discloses an example of such a vehicle operator assisting apparatus in the form of a vehicular display device. The vehicular display device of this Patent Document 1 is configured to display an image of the above-indicated virtual preceding vehicle on a transparent glass of the own vehicle in front of the vehicle operator as if the virtual preceding vehicle was running in the same running lane as the own vehicle. Described more specifically, the vehicular display device displays the virtual preceding vehicle as if the running virtual preceding vehicle was located at a position to be reached by the own vehicle when a given length of time has passed.

### PRIOR ART DOCUMENTS

### Patent Document

Patent Document 1: JP-2002-144913 A
Patent Document 2: JP-2005-069800 A
Patent Document 3: JP-2005-106663 A

### SUMMARY OF THE INVENTION

### Object Achieved by the Invention

An operator of a vehicle has a specific vehicle driving habit, that is, vehicle driving characteristics. Individual vehicle operators have respective different vehicle driving characteristics. For instance, individual vehicle operators drive the vehicle at respective different running speeds during turning of the vehicle along a curve of a roadway having a given radius of curvature. When the operator drives the own vehicle so as to follow or trace a preceding vehicle, the operator feels it more easy to follow the preceding vehicle running with driving characteristics similar to the own driving characteristics, than to follow the preceding vehicle running with driving characteristics different from the own driving characteristics. However, the vehicular display device of the above-identified Patent Document 1 is not arranged to display the virtual preceding vehicle, while taking account of the driving characteristics of the operator of the own vehicle. Namely, the virtual preceding vehicle displayed by the vehicular display device of the Patent Document 1 has a running behavior irrelevant to the driving characteristics of the operator of the own vehicle. Accordingly, the operator of the own vehicle may feel uneasy about the running behavior of the virtual preceding vehicle displayed by the vehicular display device of the Patent Document 1. Thus, the vehicular display device of the Patent Document 1 is required to be improved for reducing a driving burden on the operator during driving of the own vehicle. It is noted that this requirement is not publicly recognized.

The present invention was made in view of the background art described above. It is therefore an object of the present invention to provide a vehicle operator assisting apparatus which is configured to display the virtual preceding vehicle without uneasiness on the side of the operator of the own vehicle and which permits effective reduction of the driving burden on the operator during driving of the own vehicle.

### Means for Achieving the Object

The object indicated above is achieved according to a first aspect of the present invention, which provides a vehicle operator assisting apparatus (a) configured to display an image of a virtual preceding vehicle as if the virtual preceding vehicle was running in front of an own vehicle in a running state, such that the image is visually recognizable by an operator of the own vehicle, characterized by (b) storing a driving history of the above-described operator of the above-described own vehicle and (c) determining a running state of the above-described virtual preceding vehicle on the basis of the above-described driving history.

### Advantages of the Invention

According to the vehicle operator assisting apparatus described above, the operator visually recognizes the above-described virtual preceding vehicle as if the virtual preceding vehicle was running according to the driving characteristics of the operator, or driving characteristics similar to the driving characteristics of the operator, so that the operator may drive the above-described own vehicle so as to trace the virtual preceding vehicle, and is unlikely to feel uneasy during driving of the own vehicle. Accordingly, a driving burden on the operator can be effectively made smaller than in the case where the driving characteristics of the operator are not at all reflected on the behavior of the virtual preceding vehicle.

According to a second aspect of the invention, the vehicle operator assisting apparatus according to the above-described first aspect of the invention is configured to determine, when the above-described own vehicle is running on a road whose information is not included in the above-described driving history, the running state of the above-described virtual preceding vehicle according to driving characteristics of the above-described operator estimated on the basis of information relating to running of the above-described own vehicle, and on the basis of information on a road on which the above-described virtual preceding vehicle is to virtually run. Accordingly, even when the own vehicle is running on a road on which the operator has not ever driven the own vehicle, the driving characteristics of the operator can be reflected on the behavior of the virtual preceding vehicle, so that the driving burden on the operator can be effectively reduced even when the operator drives the own vehicle on the relevant road for the first time. It is noted that the road whose information is not included in the above-described driving history is interpreted to mean the road on which the own vehicle is driven for the first time.

According to a third aspect of this invention, the vehicle operator assisting apparatus according to the above-described first or second aspect of the invention is configured to change the running state of the above-described virtual preceding vehicle depending upon a selected one of predetermined options regarding a tendency of driving of the above-described operator. Accordingly, the running state of the above-described own vehicle driven so as to trace the above-described virtual preceding vehicle becomes similar to the running state of the virtual preceding vehicle which is changed depending upon the selected tendency of driving of the operator, such as the tendency of driving of the operator for a relatively high degree of fuel economy or a relatively high degree of drivability of the vehicle, so that the tendency of driving of the operator can be easily reflected on the running state of the own vehicle driven by the operator.

According to a fourth aspect of the invention, the vehicle operator assisting apparatus according to any one of the above-described first through third aspects of the invention is configured (a) to store a relationship between a distance between the above-described own vehicle in the running state and an actual preceding vehicle, and a running speed of the own vehicle, and (b) to determine a distance between the above-described own vehicle and the above-described virtual preceding vehicle on the basis of the stored relationship between the distance and the running speed. According to this fourth aspect of the invention, the driving characteristics of the operator are reflected on the distance between the own vehicle and the virtual preceding vehicle, so that the operator can more easily drive the own vehicle so as to trace the virtual preceding vehicle, than in the case where the distance between the own vehicle and the virtual preceding vehicle is determined irrespective of the driving characteristics of the operator.

According to a fifth aspect of the invention, the vehicle operator assisting apparatus according to any one of the above-described first through fourth aspects of the invention is configured to display the image of the above-described virtual preceding vehicle on a front window of the above-described own vehicle. Accordingly, the operator can visually recognize the image of the above-described virtual preceding vehicle as superimposed on a scene in front of the running own vehicle. Thus, it is possible to display the image of the above-described virtual preceding vehicle such that the image can be easily visually recognized by the operator who is driving the own vehicle.

The vehicle operator assisting apparatus is preferably configured such that (a) the above-described own vehicle is driven by one of a plurality of operators, (b) the above-described driving history is stored for each of the operators, and (c) the running state of the above-described virtual preceding vehicle is determined on the basis of the driving history corresponding to the operator who is presently driving the own vehicle. In this case, any one of the plurality of operators who drives the own vehicle is unlikely to feel uneasy during driving of the own vehicle so as to trace the above-described virtual preceding vehicle, and the driving burden on that operator can be effectively reduced.

Preferably, the vehicle operator assisting apparatus is configured such that when the above-described own vehicle is running on a road whose information is included in the above-described driving history, the running state of the above-described virtual preceding vehicle is determined on the basis of a virtual running pattern of the virtual preceding vehicle based on the driving history. The running of the own vehicle on the road whose information is included in the driving history means the running of the own vehicle on the road on which the own vehicle has ever been driven.

### BRIEF DESCRIPTION OF THE DRAWINGS

FIG. 1 is a view schematically showing an arrangement of a drive system of a vehicle constructed according to one embodiment of this invention;

FIG. 2 is a view showing a front window of the vehicle of FIG. 1 on which an image of a virtual preceding vehicle is displayed;

FIG. 3 is a functional block diagram illustrating major control portions of an electronic control device for controlling the vehicle of FIG. 1;

FIG. 4 is a functional block diagram for explaining in detail a virtual preceding vehicle control portion of the electronic control device of FIG. 3;

FIG. 5 is a view for explaining a manner to store roads on a map in map data stored in a map data base of the electronic control device of FIG. 3;

FIG. 6 is a view showing a driving history of the vehicle operator, that is, a running history of the vehicle, which is stored in a running history data base of the electronic control device of FIG. 3;

FIG. 7 is a view showing a virtual preceding vehicle distance map used by the electronic control device of FIG. 3 to determine a distance between the virtual preceding vehicle and the vehicle of FIG. 1;

FIG. 8 is a view for explaining a running pattern of the virtual preceding vehicle generated by the vehicle of FIG. 1 on the basis of the running history (driving history), to determine a running state of the virtual preceding vehicle;

FIG. 9 are views illustrating estimated operator's driving characteristics which are estimated driving characteristics of the operator of the vehicle of FIG. 1, and explaining a manner of determination of a provisional running state of the virtual preceding vehicle on the basis of the estimated operator's driving characteristics;

FIG. 10 is a view for explaining a method of modifying a virtual running pattern shown in FIG. 8 depending upon a tendency of driving of the vehicle operator for a relatively high degree of fuel economy of the vehicle;

FIG. 11 is a flow chart illustrating a major control operation of the electronic control device of FIG. 1, namely, a control operation to determine the running state of the virtual preceding vehicle and display the virtual preceding vehicle;

FIG. 12 is a view illustrating a sub-routine implemented in SA3 of the flow chart of FIG. 11; and

FIG. 13 is a view showing one example of tables of the running history shown in FIG. 6, which are stored in a memory for respective different vehicle operators.

### MODE FOR CARRYING OUT THE INVENTION

An embodiment of this invention will be described in detail by reference to the drawings.

### Embodiment

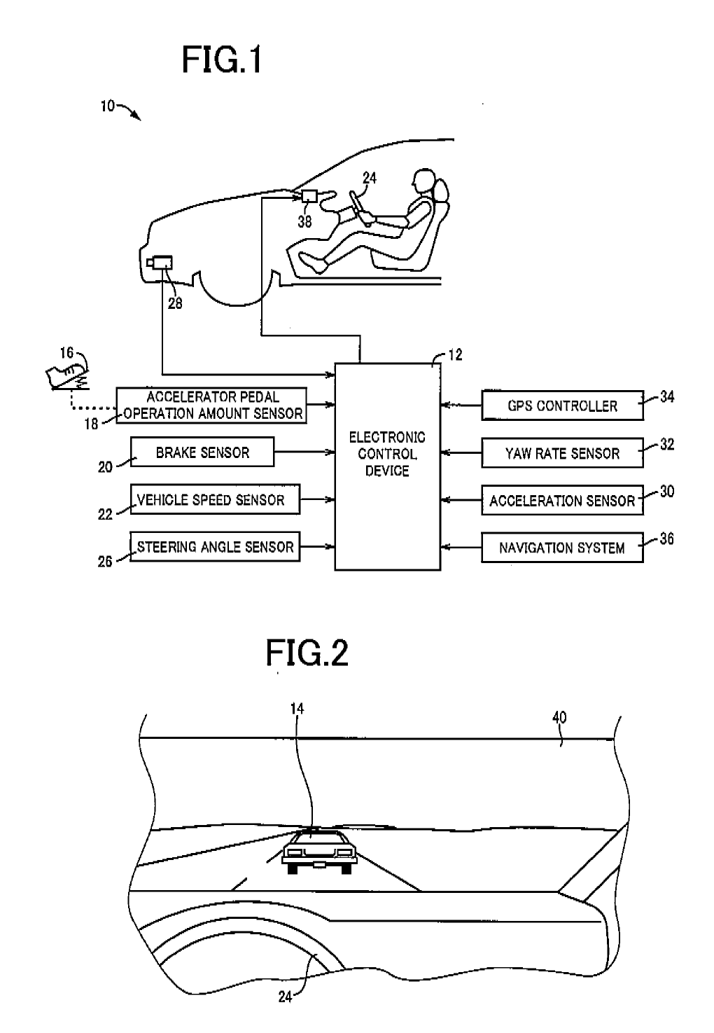

FIG. 1 is the view schematically showing an arrangement of a drive system of a vehicle 10 constructed according to one embodiment of this invention. The vehicle 10 according to this embodiment shown in FIG. 1 is an ordinary engine vehicle using an engine as a vehicle drive power source, but may be an electric vehicle or a hybrid vehicle. The vehicle 10 is provided with an electronic control device 12 configured to implement various controls of the vehicle 10, and has a control system as shown in FIG. 1 by way of example.

The electronic control device 12 shown in FIG. 1 includes a so-called microcomputer incorporating a CPU, a RAM, a ROM and an input-output interface. In the electronic control device 12, the CPU performs signal processing operations according to programs stored in the ROM, while utilizing a temporary data storage function of the RAM. For instance, the electronic control device 12 implements engine operation controls, and a shifting control of an automatic transmission, for example. Further, for reducing a driving burden on the operator the electronic control device 12 has a function of a vehicle operator assisting apparatus configured to display an image of a virtual preceding vehicle 14 as if the virtual preceding vehicle 14 was running in front of the running vehicle 10 in a running state, such that the image is visually recognizable by the operator of the vehicle 10, as shown in FIG. 2.

As shown in FIG. 1, the electronic control device 12 is configured to receive various signals from various sensors provided on the vehicle 10 driven by the operator, namely, on the own vehicle 10. For example, the electronic control device 12 receives: an output signal of an accelerator pedal operation amount sensor 18 indicative of an operation amount Acc, that is, an operation angle Acc of an accelerator pedal 16; an output signal of a brake sensor 20 indicative of an operation amount BRK of a foot brake pedal (brake operation amount BRK), which is detected on the basis of a hydraulic pressure of a master cylinder of a foot brake device; an output signal of a vehicle speed sensor 22 indicative of a running speed V of the vehicle 10; an output signal of a steering angle sensor 26 indicative of a steering angle STR of a steering wheel 24, which steering angle STR is zero during straight running of the vehicle 10; an output signal of a vehicle-to-vehicle distance sensor 28 indicative of a vehicle-to-vehicle distance DSCC between the vehicle 10 and a preceding vehicle running in front of the vehicle 10; output signals of an acceleration sensor 30 indicative of a longitudinal acceleration value and a lateral acceleration value of the vehicle 10; an output signal of a yaw rate sensor 32 indicative of a yaw rate of the vehicle 10; and output signals of a GPS controller 34 indicative of a position and a running direction of the vehicle 10, which are detected on the basis of signals received from an artificial satellite. The vehicle 10 is further provided with a navigation system 36, and the electronic control device 12 also receives navigation information such as a running route and a destination of the vehicle 10 which are set in the navigation system 36. It is noted that the vehicle-to-vehicle distance DSCC measured by the vehicle-to-vehicle distance sensor 28 is infinite, where there exists no preceding vehicle.

The electronic control device 12 commands a display device 38 to display a virtual image of the above-described virtual preceding vehicle 14 on a transparent glass in front of the operator, that is, on a front window 40 (shown in FIG. 2).

The display device 38 is installed in an upper part of an instrument panel, for example. The display device 38 displays the image of the virtual preceding vehicle 14 on the front window 40, in the form of a hologram, for instance, according to a command received from the electronic control device 12. The displayed image of the virtual preceding vehicle 14 is visually recognizable by the operator of the vehicle 10, as if the virtual preceding vehicle 14 was running in front of the running vehicle 10 such that the virtual preceding vehicle 14 leads the vehicle 10.

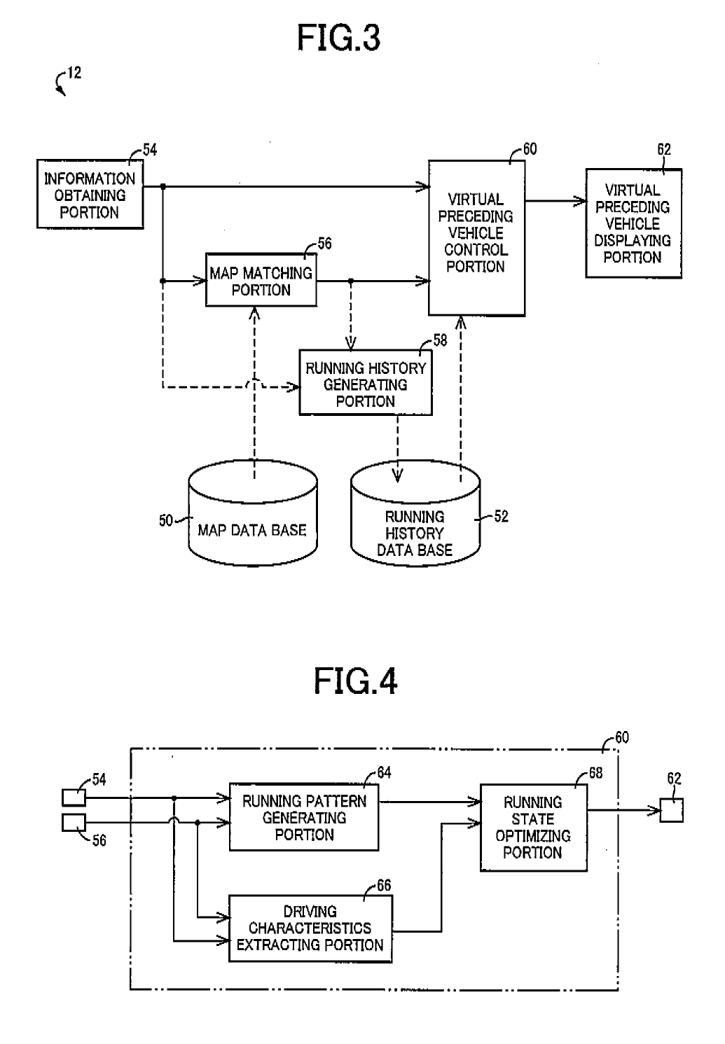

FIG. 3 is the functional block diagram illustrating major control portions of the electronic control device 12. As shown in FIG. 3, the electronic control device 12 is provided with a map data base 50, a running history data base 52, information obtaining means in the form of an information obtaining portion 54, map matching means in the form of a map matching portion 56, running history generating means in the form of a running history generating portion 58, virtual preceding vehicle control means in the form of a virtual preceding vehicle control portion 60, and virtual preceding vehicle display means in the form of a virtual preceding vehicle display portion 62. FIG. 4 is the functional block diagram for explaining in detail the above-indicated virtual preceding vehicle control portion 60. As shown in FIG. 4, the virtual preceding vehicle control portion 60 is provided with running pattern generating means in the form of a running pattern generating portion 64, driving characteristics extracting means in the form of a driving characteristics extracting portion 66, and running state optimizing means in the form of a running state optimizing portion 68.

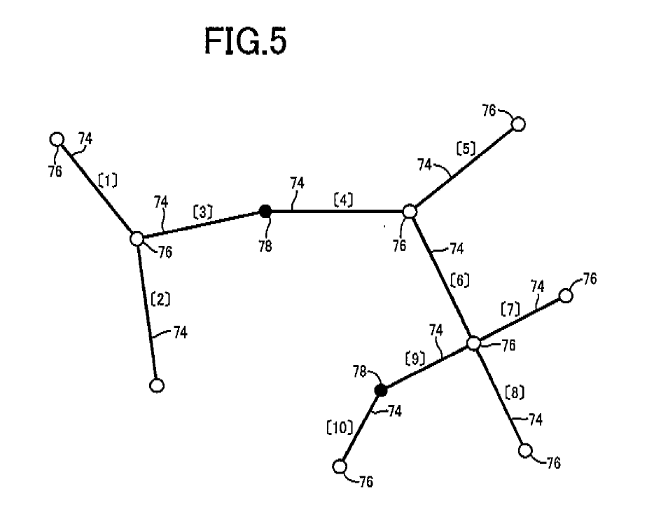

The map data base 50 shown in FIG. 3 is also used by the above-described navigation system 36. Described more specifically, this map data base 50 stores map data consisting of various kinds of information relating to a map, which include road network data representing relationships of junction of roads, for example. Namely, the map data base 50 is a memory device storing the above-indicated map data. FIG. 5 is the view for explaining a manner to store roads on the map in the map data stored in the map data base 50. That is, FIG. 5 is the view for explaining the above-indicated road network data. As shown in FIG. 5, each of the roads represented by the map data is divided and defined as a plurality of unit segments 74. Namely, each segment 74 constitutes a part of the road. For identifying each segment 74, the segment 74 is given its road number. The segments 74 in the example of FIG. 5 are given respective road numbers [1]-[10]. Further, the segments 74 are connected to each other at a node 76 (indicated by a white circle in FIG. 5) or an interpolation point 78 (indicated by a block circle in FIG. 5), according to an actual road network. The node 76 is a point at which the three or more segments 74 are connected to each other and which corresponds to an intersection of roads in the actual road network. The interpolation point 78 is a point at which the two segments 74 are connected to each other, where the actual roadways corresponding to these two segments 74 have different geometric characteristics. At least one segment 74 extending directly between the two nodes 76 without any other node 76 located between those two nodes 76 is called a link as a whole. For instance, in FIG. 5, the segments 74 which have the respective road numbers [3] and [4] and which are connected to each other at the interpolation point 78 constitute one link, while the segment 74 having the road number [6] constitutes another link. The above-described map data include road information relating to the roads corresponding to the individual segments 74, more specifically, road information including at least information relating to the geometric characteristics of the roads such as their positions, lengths, gradients, widths, radii of curvature of turning, etc., which are stored in relation to the road numbers. Thus, the plurality of segments 74 represented by the map data are stored such that they are connected to each other at the node 76 or interpolation point 78 according to the actual road network. The roads can be specified by the road numbers given to the respective segments 74, and the road information of the roads specified by the road numbers can be obtained. In the following description, the road specified by a given road number, that is, the road corresponding to a given segment 74 will be referred to as a unit road.

The information obtaining portion 54 shown in FIG. 3 is configured to obtain vehicle-running-related information relating to the running of the vehicle 10 successively. For example, the vehicle-running-related information is obtained on the basis of the signals received from the sensors shown in FIG. 1, and includes the location (own vehicle location), running speed V, running direction, attitude (e.g., radius of turning), accelerator pedal operation amount Acc and brake operation amount BRK of the vehicle 10. Where the vehicle 10 is a hybrid vehicle, the vehicle-running-related information may include information characteristic of the hybrid vehicle, such as an electric energy amount SOC stored in an electric-energy storage device.

The information obtaining portion 54 determines the absence of any preceding vehicle, if the vehicle-to-vehicle distance DSCC detected by the vehicle-to-vehicle distance sensor 28 is not smaller than a threshold value predetermined by experimentation for determination of the presence or absence of the preceding vehicle. If the information obtaining portion 54 determines the presence of the preceding vehicle, the information obtaining portion 54 obtains from time to time the vehicle-to-vehicle distance DSCC detected by the vehicle-to-vehicle distance sensor 28, in addition to the above-indicated items of the vehicle-running-related information.

The map matching portion 56 is configured to specify from time to time the above-described unit road (segment 74) on which the vehicle 10 is presently running, according to the above-described map data stored in the map data base 50, and on the basis of the own vehicle location as represented by the latitude and longitude obtained by the information obtaining portion 54, like the ordinary navigation system 36 specifies the unit road (segment 74) corresponding to the own vehicle location, on the basis of the own vehicle location. The map matching portion 56 obtains from time to time the road number of the specified unit road. Namely, the map matching portion 56 specifies from time to time the road number of the unit road on which the vehicle 10 is presently running. In other words, the map matching portion 56 implements from time to time a map matching operation to specify the unit road on which the vehicle 10 is presently running, or the road number of that unit road, by checking the own vehicle location obtained by the information obtaining portion 54, against the above-described map data. The unit road on which the vehicle 10 is presently running can be specified if any road stored in the map data base 50 exists at the above-indicated own vehicle location. A state in which the road (unit road) on which the vehicle 10 is presently running can be specified is referred to as “an on-road state” of the vehicle 10, while a state in which any road stored in the map data base 50 does not exists at the own vehicle location and the road on which the vehicle 10 is presently running cannot be specified is referred to as “an off-road state” of the vehicle 10.

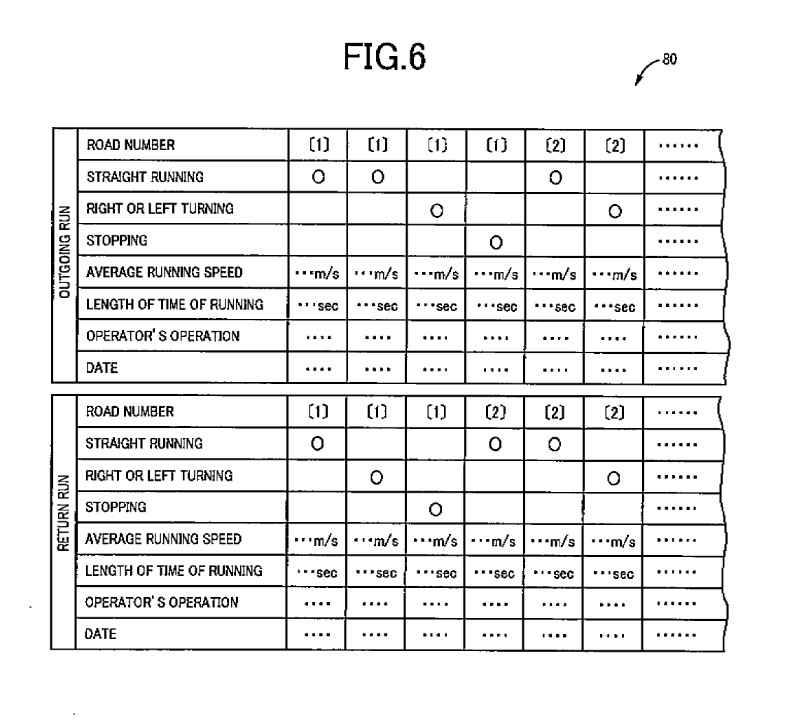

When the vehicle 10 is placed in the on-road state, the running history generating portion 58 stores a driving history 80 of the operator of the vehicle 10, namely, a running history 80 of the vehicle 10, in the running history data base 52, on the basis of the above-described vehicle-running-related information obtained by the information obtaining portion 54, and the road numbers of the unit roads specified by the map matching portion 56. That is, the running history generating portion 58 stores the running history 80 during individual runs of the vehicle 10. In other words, the running history generating portion 58 implements a learning operation to obtain the running history (driving history) 80. The running history data base 52 is a memory device storing the above-indicated running history (driving history) 80, and may be called a driving history data base. FIG. 6 is the view showing an example of the contents of the running history data base 52.

In the example of FIG. 6, the running history 80 stored in the running history data base 52 includes: the above-indicated road number of each road (unit road) corresponding to each segment 74; an average speed Vav of running of the vehicle 10 on the unit road of each road number; a length of time of running of the vehicle 10 on each unit road; an operation performed by the operator of the vehicle 10 during its running on each unit road; and a date of running of the vehicle 10 on each unit road. The above-indicated items of the running history 80 are stored in relation to the road numbers. For the same road number, the running history 80 is stored separately with respect to a straight running of the vehicle 10 on the unit road of the relevant road number, a right or left turning of the vehicle 10 on the unit road, and a stopping of the vehicle 10 at an intersection corresponding to the node 76 after running on the unit road. Further, the running history 80 is stored separately with respect to an outgoing run and a return run of the vehicle 10 corresponding to the opposite directions of running of the vehicle 10 on the unit road of the relevant road number. The above-indicated average running speed Vav is calculated by dividing the length of the unit road by the above-indicated length of time of running of the vehicle 10, for instance. The operator's operation included in the running history 80 more specifically means an operation of the accelerator pedal and an operation of the foot brake pedal. The average accelerator pedal operation amount Acc and the average brake operation amount BRIE are stored as the operator's operation. The operator's operation may further include an operation of a turn signal indicator, and any other operation other than the accelerator pedal and foot brake pedal operations. The above-indicated date of running of the vehicle 10 may be the date at which the running of the vehicle 10 on the unit road is initiated or terminated. The right and left turnings of the vehicle 10 can be determined from a change of the running direction of the vehicle 10 obtained by the information obtaining portion 54, and the outgoing and return runs can be distinguished from each other from the running direction.

When the vehicle 10 has passed each road (unit road) corresponding to each unit segment 74, the appropriate running data such as the average running speed Vav and the length of running time as indicated in FIG. 6 are stored for a road number as part of the running history (driving history) 80 which consists of the items explained above. For this purpose, the running history generating portion 58 receives from time to time the above-indicated vehicle-running-related information obtained by the information obtaining portion 54, and the road numbers of the unit roads specified by the map matching portion 56. When the vehicle 10 has passed one unit road, that is, when the road number of the unit road specified by the map matching portion 56 is changed from one to another, the running history generating portion 58 updates the running history 80 by adding the running data on the basis of the received vehicle-running-related information and road numbers. In the example of the running history 80 shown in FIG. 6, there exist two straight runs on the unit road of the road number [1] during the outgoing run, which two straight runs take place on different dates. It is to be understood that the running history 80 is shown in FIG. 6 by way of example, only, and may further include other items relating to the running of the vehicle 10, or some of the items included in the running history 80 of FIG. 6 may be eliminated.

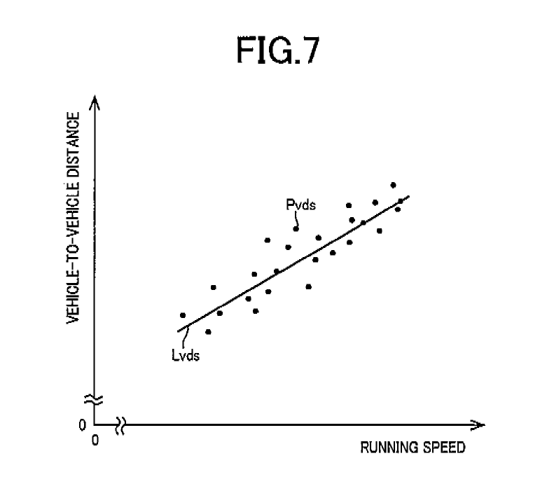

The running history generating portion 58 receives from time to time the vehicle-to-vehicle distance DSCC detected by the vehicle-to-vehicle distance sensor 28, and the vehicle pinning speed V detected by the vehicle speed sensor 22 from the information obtaining portion 54, as well as stores the running history 80 as described above. These vehicle-to-vehicle distance DSCC and the vehicle running speed V are obtained from time to time simultaneously or substantially simultaneously. The running history generating portion 58 stores from time to time a relationship between the vehicle-to-vehicle distance DSCC received from the information obtaining portion 54 and the vehicle running speed V, that is, an actual distance-running speed relationship point Pvds. For instance, the running history generating portion 58 receives the relationship between the vehicle-to-vehicle distance DSCC and the vehicle running speed V at a predetermined time interval, and stores the received relationship, that is, the actual distance-running speed relationship point Pvds. FIG. 7 is the view showing an example of the successively stored actual distance-running speed relationship points Pvds, which are indicated by respective black dots. On the basis of the stored actual distance-running speed relationship points Pvds, the running history generating portion 58 generates a virtual preceding vehicle distance map Lvds indicted by a solid line Lvds in FIG. 7, which is the relationship between the vehicle-to-vehicle distance DSCC and the vehicle running speed V and which is used to determine the location of the virtual preceding vehicle 14. For example, this virtual preceding vehicle distance map Lvds is obtained by a least squares method, as a continuous line of relationship between the vehicle-to-vehicle distance DSCC and the vehicle running speed V, which approximates the plurality of actual distance-running speed relationship points Pvds. This virtual preceding vehicle distance map Lvds is preferably updated each time the actual distance-running speed relationship point Pvds is added.

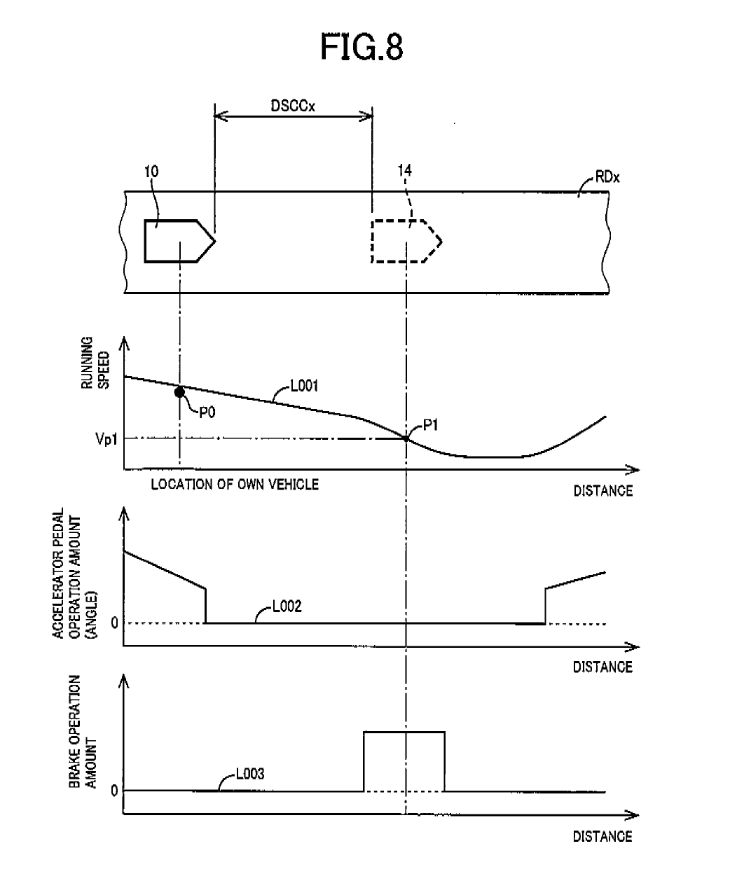

The virtual preceding vehicle control portion 60 determines from time to time the running state of the above-described virtual preceding vehicle 14, and commands the virtual preceding vehicle display portion 62 to display the virtual preceding vehicle 14 in the determined running state from time to time. For this purpose, the running pattern generating portion 64 included in the virtual preceding vehicle control portion 60 receives from time to time the vehicle-running-related information obtained by the information obtaining portion 54, and the road number of the unit road on which the vehicle 10 is presently running, which unit road is specified by the map matching portion 56. Where the vehicle 10 is presently running on the road (once running road) stored in the running history (driving history) 80, namely, on the road on which the vehicle 10 has already run, the running pattern generating portion 64 generates, on the basis of the running history 80, a running pattern of the virtual preceding vehicle 14 which determines the running state of the virtual preceding vehicle 14. For example, the running state of the virtual preceding vehicle 14 is represented by the running speed V, attitude (direction of running) of the virtual preceding vehicle 14, etc., which are to be recognized by the operator. The above-indicated once running road is the road on which the vehicle 10 has ever run in the past. Referring to FIG. 8, the generation of the running pattern of the virtual preceding vehicle 14 on the basis of the above-described running history 80 will be described.

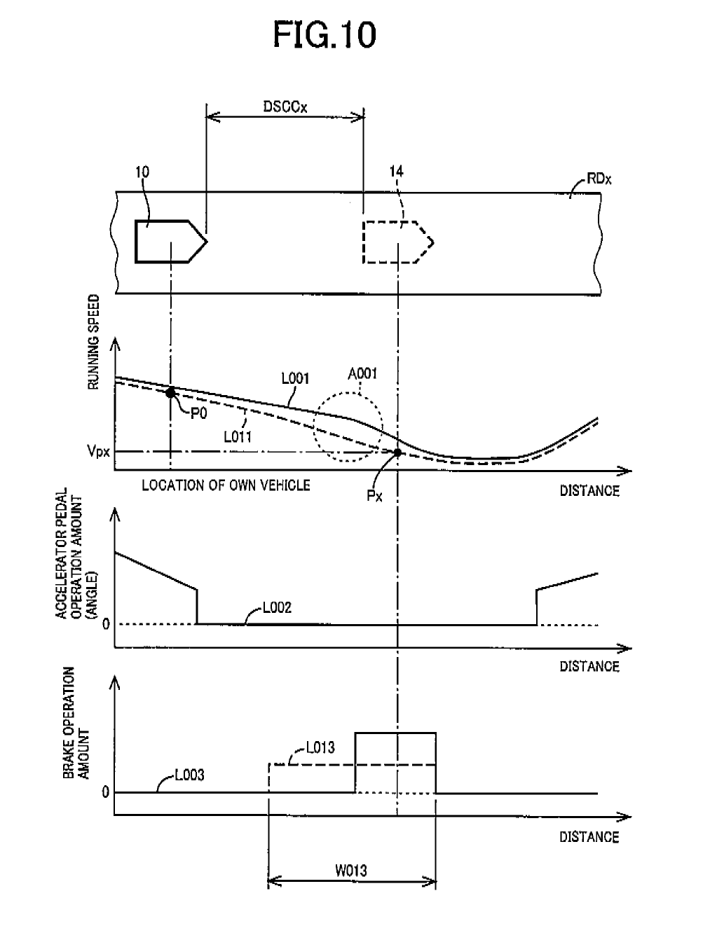

FIG. 8 is the view for explaining the running pattern of the virtual preceding vehicle 14 generated on the basis of the running history 80 to determine the running state of the virtual preceding vehicle 14. The virtual preceding vehicle control portion 60, which can obtain the location of the vehicle 10 on the basis of the road number received from the map matching portion 56, is configured to generate, on the basis of the running history 80, a relationship among the distance from the own vehicle location indicated by a point P0 in FIG. 8, for example, to a predetermined destination in a vehicle running direction, the vehicle running speed V, accelerator pedal operation amount Acc and the brake operation amount BRK. The thus generated relationship represents the running pattern of the virtual preceding vehicle 14, that is, a virtual running pattern. The route of running of the vehicle 10 according to the virtual running pattern may be a straight route from the location of the vehicle 10 according to the map data stored in the map data base 50, or a route set in the navigation system 36. The vehicle running speed V in the virtual running pattern may be an average of the values of the average vehicle running speed Vav of the running data which are coincident with those in the running history 80 in terms of the road number, straight running or right or left turning, stopping, and outgoing or return run, or may be the average vehicle running speed Vav of the latest running data coincident with those in the running history 80 in terms of the road number. The above description with respect to the vehicle running speed V applies to the accelerator pedal operation amount Acc and the brake operation amount BRK in the virtual, running pattern. “RDx” in FIGS. 8 and 10 represents the road on which the vehicle 10 and the virtual preceding vehicle 14 are assumed to run according to the virtual running pattern.

With the running state of the virtual preceding vehicle 14 being determined according to the thus generated virtual running pattern, the virtual preceding vehicle 14 is assumed to run in front of the vehicle 10, at a location determined in relation to the location of the vehicle 10, as indicated in FIG. 8. The running state of the virtual preceding vehicle 14 is determined on the basis of the assumed location of the virtual preceding vehicle 14 and according to the virtual running pattern. In the example of FIG. 8 wherein the virtual preceding vehicle 14 is running at the assumed location indicated by a point P1, the running speed V of the virtual preceding vehicle 14 is Vp1 represented by the point P1.

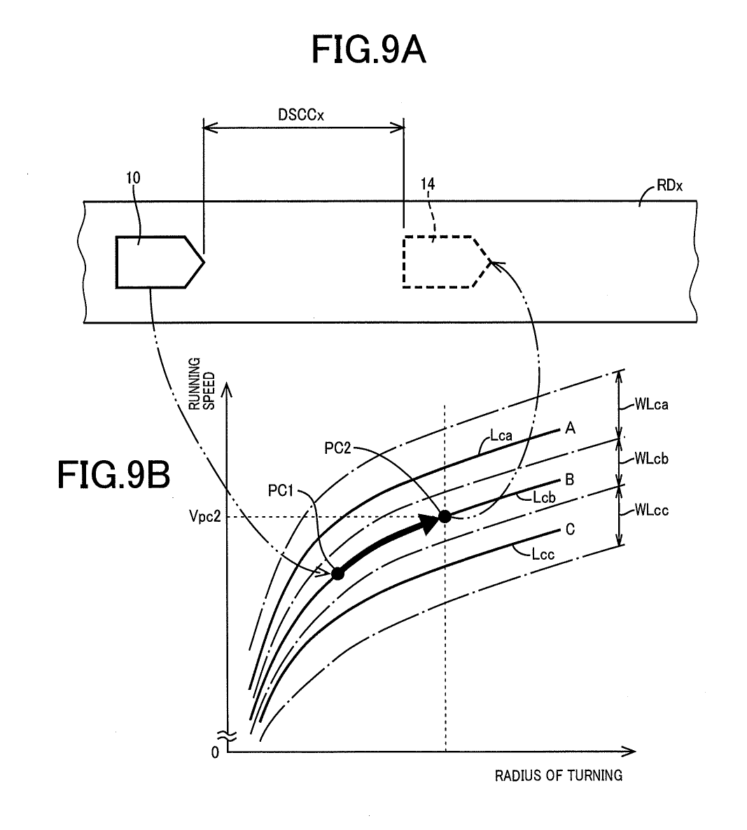

The driving characteristics extracting portion 66 included in the virtual preceding vehicle control portion 60 receives from time to time the above-described vehicle-running-related information obtained by the information obtaining portion 54. On the basis of the received vehicle-running-related information, for example, the running state represented by the vehicle running speed V and radius of turning, the driving characteristics extracting portion 66 estimates driving characteristics of the operator, which are characteristics specific to the operator and relating to the running state of the vehicle 10. The estimated driving characteristics of the operator (estimated operator's driving characteristics) are represented by solid lines Lca, Lcb and Lcc in FIG. 9(b). The manner of determination of the estimated operator's driving characteristics will be described with respect to the example of FIG. 9(b).

FIG. 9(b) indicates the three estimated operator's driving characteristics lines Lca, Lcb and Lcc, in the order from the highest running speed characteristic line Lca. For obtaining the estimated operator's driving characteristics lines Lca, Lcb and Lcc, there are provided respective data reference ranges WLca, WLcb and WLcc in advance, in the order from the highest running speed. The driving characteristics extracting portion 66 determines the estimated operator's driving characteristic line Lca such that the line Lca approximates all points representative of the vehicle running speed V and radius of turning included in the vehicle-running-related information obtained from time to time, which points lie within the data reference range WLca as a curved line. The method of determining this approximation line Lca may be an ordinary one, and is not particularly limited. The other estimated operator's driving characteristics lines Lcb and Lcc are determined in the same manner as the estimated operator's driving characteristic line Lca. Thus, the estimated operator's driving characteristics are determined on the basis of the vehicle-running-related information obtained from time to time. Namely, the driving characteristics extracting portion 66 updates the estimated operator's driving characteristics each time the vehicle-running-related information is obtained.

Where the vehicle 10 is presently running on the road (non-once-running road) not included in the running history (driving history) 80, the driving characteristics extracting portion 66 determines from time to time a provisional running state of the virtual preceding vehicle 14 on the basis of the above-described estimated operator's driving characteristics. The provisional running state is provisional in the sense that the provisional running state may be modified by the running state optimizing portion 68. The manner of determination of the provisional running state will be described by reference to FIG. 9.

For determining the above-indicated provisional running state, the driving characteristics extracting portion 66 initially obtains the vehicle-to-vehicle distance DSCC on the basis of the running speed V of the vehicle 10 obtained by the information obtaining portion 54, and according to the virtual preceding vehicle distance map Lvds indicated in FIG. 7. The vehicle-to-vehicle distance DSCC thus obtained according to the virtual preceding vehicle distance map Lvds is an assumed virtual preceding vehicle distance DSCCx between the vehicle 10 and the virtual preceding vehicle 14. Namely, as shown in FIG. 9(a), the driving characteristics extracting portion 66 estimates the location of the virtual preceding vehicle 14, assuming that the virtual preceding vehicle 14 is running in front of the vehicle 10 with the virtual preceding vehicle distance DSCCx left therebetween, with respect to the road number obtained by the map matching portion 56, that is, with respect to the own vehicle location represented by the road number. The route of running of the vehicle 10 in this case may be a straight route from the location of the vehicle 10 according to the map data stored in the map data base 50, or a route set in the navigation system 36, like the route of running described above with respect to the generation of the virtual running pattern. Further, the driving characteristics extracting portion 66 selects one of the three estimated operator's driving characteristic lines Lca, Lcb and Lcc indicated in FIG. 9(b), which is the estimated operator's driving characteristic line Lcb that is closest to a point PC1 representative of the radius of turning and vehicle running speed V obtained by the information obtaining portion 54. Then, the driving characteristics extracting portion 66 obtains the radius of curvature of the road at the above described estimated location of the virtual preceding vehicle 14, on the basis of the map data stored in the map data base 50, and determines the obtained radius of curvature of the road as the radius of turning of the virtual preceding vehicle 14. Then, the driving characteristics extracting portion 66 determines a vehicle running speed Vpc2 at a point PC2 indicated in FIG. 9(b), as the running speed V of the virtual preceding vehicle 14, on the basis of the radius of turning of the virtual preceding vehicle 14, and according to the selected estimated operator's driving characteristic line Lcb. In the manner described above, the driving characteristic extracting portion 66 determines the above-indicated provisional running state of the virtual preceding vehicle 14, according to the estimated operator's driving characteristics indicated in FIG. 9(b), and on the basis of the running state (e.g., running speed V and radius of turning) of the vehicle 10 obtained by the information obtaining portion 54, and the information (e.g., radius of curvature) on the road on which the virtual preceding vehicle 14 is virtually running, namely, the information on the road corresponding to the above-indicated estimated location. It is noted that “RDx” in FIG. 9(a) represents the road on which the vehicle 10 and the virtual preceding vehicle 14 are assumed to run according to the virtual running pattern in determining the provisional running state.

The running state optimizing portion 68 is configured to modify the running state of the virtual preceding vehicle 14 depending upon a tendency of driving of the operator. Described more specifically, the running state optimizing portion 68 modifies the virtual running pattern (hereinafter referred to as “reference virtual running pattern”) generated by the running pattern generating portion 64 into a running pattern suitable for the tendency of driving of the operator, to determine this running pattern as the running state of the virtual preceding vehicle 14, where the vehicle 10 is presently running on any once running road. Where the vehicle 10 is presently running on any non-once-running road, the running state optimizing portion 68 modifies the provisional running state of the virtual preceding vehicle 14 determined by the driving characteristics extracting portion 66, into a running state suitable for the tendency of driving of the operator, to determine this running state as the running state of the virtual preceding vehicle 14. The tendency of driving of the operator means a tendency regarding the operator's desired vehicle performance as represented by one of the fuel economy and the drivability of the vehicle, which performance is to be achieved by the manner of driving of the vehicle by the operator. In the present embodiment, the tendency of driving of the operator is selected from among two options: a tendency of driving for a relatively high degree of fuel economy of the vehicle; and a tendency of driving for a relatively high degree of drivability of the vehicle. For instance, the running state optimizing portion 68 determines that the tendency of driving for the relatively high degree of drivability of the vehicle is selected, if a sporty drive mode selector switch, which is turned on by the vehicle operator when the operator desires shifting actions of an automatic transmission for the relatively high degree of drivability, is placed in its on state. On the other hand, the running state optimizing portion 68 determines that the tendency of driving for the relatively high degree of fuel economy of the vehicle is selected, if the sporty drive mode selector switch is placed in its off state.

Referring to FIG. 10, there will be described one example in which the running state optimizing portion 68 modifies the reference virtual running pattern into the virtual running pattern suitable for the tendency of driving of the operator for the relatively high degree of fuel economy of the vehicle. FIG. 10 is the view for explaining the method of modifying the reference virtual running pattern shown in FIG. 8 into the virtual running pattern suitable for the tendency of the vehicle operator for the relatively high degree of fuel economy of the vehicle. Solid lines L001, L002 and L003 indicated in FIG. 10 are equivalent to the respective solid lines L001, L002 and L003 indicated in FIG. 8.

In the example of the reference virtual running pattern of FIG. 10, the foot brake pedal is temporarily operated, so that the vehicle running speed V is temporarily reduced at a relatively high rate, as indicated in an area indicated by a broken line A001. Accordingly, the running state optimizing portion 68 modifies the reference virtual running pattern indicated by the solid line L001 into a virtual running pattern indicated by a broken line L011, in which the rate of reduction of the vehicle running speed V is relatively low for an improved degree of fuel economy of the vehicle. For obtaining the virtual running pattern indicated by the broken line L011, for example, the running state optimizing portion 68 assumes the brake operation amount BRK indicated by the solid line L003 into the reduced brake operation amount BRK indicated by a broken line L013, while preventing a change of the vehicle running speed V upon termination of the foot brake pedal operation. Then, the running state optimizing portion 68 calculates a rate of reduction of the vehicle running speed V on the basis of the brake operation amount BRK indicated by the broken line L013 and a time duration W013 of the foot brake pedal operation, and according to a relationship predetermined by experimentation, and generates a relationship between the vehicle running speed V indicated by the broken line L011 and the distance from the own vehicle location in the vehicle running direction, namely, generates the virtual running pattern suitable for the tendency of driving of the operator for the relatively high degree of fuel economy of the vehicle. As described above by way of example, the running state optimizing portion 68 modifies the reference virtual running pattern generated by the running pattern generating portion 64, into the virtual running pattern suitable for the tendency of driving of the operator for the relatively high degree of fuel economy of the vehicle.

While the modification of the virtual running pattern has been described above for illustrative purpose by reference to FIG. 10, the running state optimizing portion 68 may be configured to modify the reference virtual running pattern, also when it is determined that the tendency of driving of the operator for the relatively high degree of drivability of the vehicle is selected, such that the relationship between the vehicle running speed V and the distance from the own vehicle location in the vehicle running direction is changed for raising the vehicle running speed V by a predetermined amount. The running state optimizing portion 68 may be configured to modify the relationship between the vehicle running speed V and the distance from the own vehicle location in the vehicle running direction such that the vehicle running speed V is lowered by a predetermined amount, when it is determined that the tendency of driving of the operator for the relatively high degree of fuel economy of the vehicle is selected.

The running state optimizing portion 68 determines the reference virtual running pattern modified depending upon the tendency of driving of the operator, as the virtual running pattern, namely, as the running state of the virtual preceding vehicle 14. Described by reference to FIG. 10, the running state optimizing portion 68 initially obtains the above-described virtual preceding vehicle distance DSCCx in the same manner as the driving characteristics extracting portion 66, to determine the running state of the virtual preceding vehicle 14. Namely, like the driving characteristics extracting portion 66, the running state optimizing portion 68 determines the assumed location of the virtual preceding vehicle 14, which is spaced from the own vehicle location by the above-indicated virtual preceding vehicle distance DSCCx in the vehicle running direction, as indicated in FIG. 10. Then, the running state optimizing portion 68 determines the running state of the virtual preceding vehicle 14, on the basis of the assumed location of the virtual preceding vehicle 14 and according to the virtual running pattern modified as described above. In the example of FIG. 10 wherein the virtual preceding vehicle 14 is running at the assumed location indicated by a point Px, the running speed V of the virtual preceding vehicle 14 is equal to a value Vpx represented by the point Px, according to the virtual running pattern indicated by the broken line L011. Thus, the running state of the virtual preceding vehicle 14 is determined such that the virtual preceding vehicle 14 is running at the assumed location indicated by the point Px, at the running speed Vpx. It is noted that a broken line L011 in FIG. 10 is exaggeratedly offset below the solid line L001, for easier understanding of the figure.

Where the vehicle 10 is presently running on the non-once-running road, the running state optimizing portion 68 modifies the provisional running state of the virtual preceding vehicle 14 determined by the driving characteristics extracting portion 66, depending upon the tendency of driving of the operator, as described above. Where it is determined that the tendency of driving of the operator for the relatively high degree of drivability of the vehicle is selected, the running state optimizing portion 68 may raise the running speed V in the above-described provisional running state by a predetermined amount, upon determination of the running state of the virtual preceding vehicle 14. Where it is determined that the tendency of driving of the operator for the relatively high degree of fuel economy of vehicle is selected, the running state optimizing portion 68 may lower the running speed V in the provisional running state by a predetermined amount, upon determination of the running state of the virtual preceding vehicle 14.

After the running state optimizing portion 68 has determined the running state of the virtual preceding vehicle 14 in the manner described above, the virtual preceding vehicle control portion 60 commands from time to time the virtual preceding vehicle display portion 62 to display the virtual preceding vehicle 14 as if the virtual preceding vehicle 14 was running in the determined running state. According to the commands received from the virtual preceding vehicle control portion 60, the virtual preceding vehicle display portion 62 commands the display device 38 to display an image of the virtual preceding vehicle 14 on the front window (front windshield) 40 as if the virtual preceding vehicle 14 was running in the determined running state.

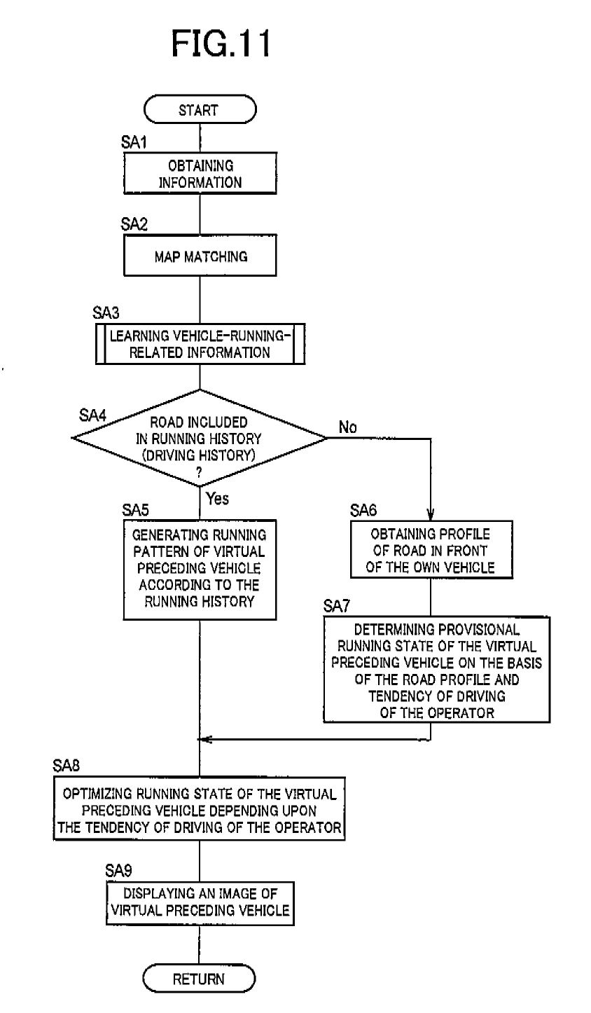

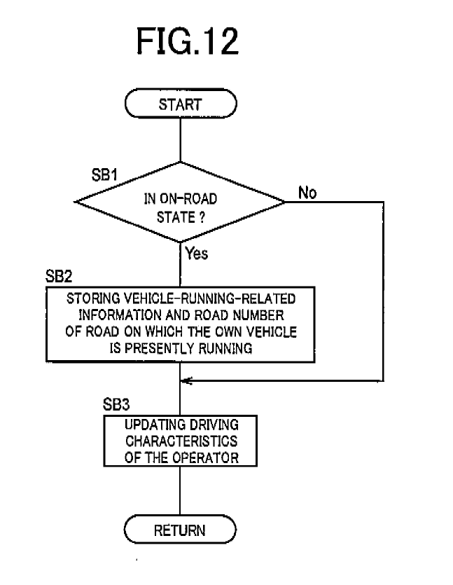

FIG. 11 is the flow chart illustrating a major control operation of the electronic control device 12, namely, a control operation to determine the running state of the virtual preceding vehicle 14 and display the image of the virtual preceding vehicle 14. The control operation is repeatedly performed with an extremely short cycle time of about several milliseconds to about several tens of milliseconds. This control operation illustrated in FIG. 11 may be performed alone, or concurrently with any other control operation. FIG. 12 is the view illustrating a sub-routine implemented in SA3 of the flow chart of FIG. 11.

The control operation of FIG. 11 is initiated with step SA1 (hereinafter “step” being omitted) to obtain the above-described vehicle-running-related information during running of the vehicle 10. The vehicle-running-related information represents the running state of the vehicle 10, and includes the location (own vehicle location), running speed V, direction of running, attitude (e.g., radius of turning), accelerator pedal operation amount Acc and brake operation amount BRK of the vehicle 10, for instance. SA1 is followed by SA2. It will be understood that SA1 corresponds to the information obtaining portion 54.

SA2 corresponding to the map matching portion 56 is implemented to specify the above-described unit road (segment 74) on which the vehicle 10 is presently running, on the basis of the own vehicle location obtained in SA1 and according to the above-described map data stored in the map data base 50. In other words, the above-described map matching operation is performed in SA2. SA2 is followed by SA3.

SA3 is implemented to learn the above-described vehicle-running-related information, more specifically, to implement the sub-routine illustrated in FIG. 12.

SB1 of FIG. 12 is implemented to determine whether the vehicle 10 is placed in the above-indicated on-road state. If an affirmative determination is obtained in SB1, that is, if the vehicle 10 is placed in the on-road state, the control flow goes to SB2. If a negative determination is obtained in SB1, the control flow goes to SB3.

SB2 is implemented to store the vehicle-running-related information obtained in SA1 and the road number of the unit road specified in SA2 as the above-described running history (driving history) 80 in the running history data base 52 (as indicated in FIG. 6). SB2 is followed by SB3. It will be understood that SB1 and SB2 correspond to the running history generating portion 58.

SB3 corresponding to the driving characteristics extracting portion 66 is implemented to update the above-described estimated operator's driving characteristics as represented by the solid lines Lca, Lcb and Lcc, in FIG. 9(b) on the basis of the vehicle-running-related information obtained in SA1 such as the running speed V and radius of turning of the vehicle 10. After the estimated operator's driving characteristics are updated, the control flow goes to SA4 of FIG. 11.

Referring back to FIG. 11, SA4 corresponding to the running pattern generating portion 64 and the driving characteristics extracting portion 66 is implemented to determine whether the vehicle 10 is presently running on the road whose information is included in the running history 80, namely, on the above-described once running road. If an affirmative determination is obtained in SA4, that is, if the vehicle 10 is presently running on the once running road, the control flow goes to SA5. If a negative determination is obtained in SA4, that is, if the vehicle 10 is presently running on the above-described non-once-running road, the control flow goes to SA6.

SA5 corresponding to the running pattern generating portion 64 is implemented to generate the running pattern of the virtual preceding vehicle 14 determining the running state of the virtual preceding vehicle 14, namely, the above-described virtual running pattern, on the basis of the running history 80 stored in the running history data base 52. SA5 is followed by SA8.

SA6 corresponding to the driving characteristics extracting portion 66 is implemented to obtain the above-described virtual preceding vehicle distance DSCCx, according to the virtual preceding vehicle distance map Lvds indicated in FIG. 7, and determine the assumed location of the virtual preceding vehicle 14, assuming that the virtual preceding vehicle 14 is running in front of the vehicle 10 with the virtual preceding vehicle distance DSCCx left therebetween. Then, in SA6, the profile of the road at the assumed location of the virtual preceding vehicle 14, more specifically, the radius of curvature of the road is obtained according to the map data base 50. SA6 is followed by SA7.

SA7 corresponding to the driving characteristics extracting portion 66 is implemented to determine the above-described provisional running state of the virtual preceding vehicle 14 assumed to run so as to follow the profile (radius of curvature) of the road obtained in SA6, on the basis of the obtained profile of the road and the estimated operator's driving characteristics represented in FIG. 9(b). SA7 is followed by SA8.

SA8 corresponding to the running state optimizing portion 68 is implemented to optimize the running state of the virtual preceding vehicle 14 depending upon the tendency of driving of the operator. Described more specifically, where SA8 is implemented after the virtual running pattern is generated in SA5, this virtual running pattern is modified to determine the running state of the virtual preceding vehicle 14, depending upon the tendency of driving of the operator. Where SA8 is implemented after the provisional running state is determined in SA7, this provisional running state is modified to determine the running state of the virtual preceding vehicle 14, depending upon the tendency of driving of the operator. SA8 is followed by SA9.

SA9 corresponding to the virtual preceding vehicle control portion 60 and the virtual preceding vehicle display portion 62 is implemented to command the display device 38 to display an image of the virtual preceding vehicle 14 on the front window 40, as if the virtual preceding vehicle 14 was running in the running state determined in SA8.

The present embodiment is configured such that the driving history 80 of the operator of the vehicle 10, namely, the running history 80 of the vehicle 10 is stored in the running history data base 52, and the running pattern of the virtual preceding vehicle 14 is generated on the basis of the running history (driving history) 80, so that the running state of the virtual preceding vehicle 14 is determined on the basis of the generated running pattern of the virtual preceding vehicle 14. Namely, the running state of the virtual preceding vehicle 14 is determined on the basis of the above-indicated running history 80. Therefore, the operator visually recognizes the virtual preceding vehicle 14 as if the virtual preceding vehicle 14 was running according to the driving characteristics of the operator, or driving characteristics similar to the driving characteristics of the operator, so that the operator may drive the vehicle 10 so as to trace the virtual preceding vehicle 14, and is unlikely to feel uneasy during driving of the vehicle 10. Accordingly, the driving burden on the operator can be effectively made smaller than in the case where the driving characteristics of the operator are not at all reflected on the behavior of the virtual preceding vehicle 14. Further, the running history 80 is stored in relation to each road number, as indicated in FIG. 6, so that the running state of the virtual preceding vehicle 14 can be determined suitably according to the specific conditions of the individual roads, such as bad visibility or openness of the road, and a small width of the road.

The present embodiment is further configured to estimate the driving characteristics of the operator represented by the solid lines Lca, Lcb and Lcc in FIG. 9(b), on the basis of the vehicle-running-related information relating to running of the vehicle 10, for example, on the basis of the running speed V and radius of turning of the vehicle 10. When the vehicle 10 is presently running on the above-described non-once-running road whose information is not included in the running history (driving history) 80, the provisional running state of the virtual preceding vehicle 14 is determined according to the estimated driving characteristics of the operator, and on the basis of the running state of the vehicle 10 (e.g., running speed V and radius of turning), and the information on the road on which the virtual preceding vehicle 14 is to virtually run (radius of curvature of the road, for instance). This provisional running state is modified depending upon the driving characteristics of the operator, and the modified provisional running state is determined as the running state of the virtual preceding vehicle 14. That is, the running state of the virtual preceding vehicle 14 is determined based on the driving characteristics of the operator, and on the basis of the running state of the vehicle 10 and the information on the road on which the virtual preceding vehicle 14 is to virtually run. Accordingly, even when the vehicle 10 is running on a road on which the operator has not ever driven the vehicle 10, the driving characteristics (driving habits, for example) of the operator can be reflected on the behavior of the virtual preceding vehicle 14, so that the driving burden on the operator can be effectively reduced even when the operator drives the vehicle 10 on the relevant road, for the first time.

The present embodiment is also configured to change the running state of the virtual preceding vehicle 14 depending upon a selected one of the predetermined options regarding the tendency of driving of the operator, such as the tendency of driving of the operator for a relatively high degree of fuel economy of the vehicle, or the tendency of driving of the operator for a relatively high degree of drivability of the vehicle. Accordingly, the running state of the vehicle 10 driven so as to trace the virtual preceding vehicle 14 becomes similar to the running state of the virtual preceding vehicle 14 which is changed depending upon the selected tendency of driving of the operator, so that the tendency of driving of the operator can be easily reflected on the running state of the vehicle 10 driven by the operator.

The present embodiment is further configured to store from time to time the relationship between the distance DSCC between the vehicle 10 in the running state and the actual preceding vehicle, and the running speed V of the vehicle 10, namely, the above-described actual distance-running speed relationship points Pvds (indicated in FIG. 7), and to generate the above-described virtual preceding vehicle distance map Lvds on the basis of the stored actual distance-running speed relationship points Pvds, as indicated by the solid line Lvds in FIG. 7. The virtual preceding vehicle distance DSCCx between the vehicle 10 and the virtual preceding vehicle 14 is determined on the basis of the above-indicated virtual preceding vehicle distance map Lvds. Namely, the virtual preceding vehicle distance DSCCx is determined on the basis of the stored relationship (actual distance-running speed relationship points Pvds) between the distance DSCC and the running speed V of the vehicle 10. Accordingly, the driving characteristics of the operator are reflected on the virtual preceding vehicle distance DSCCx between the vehicle 10 and the virtual preceding vehicle 14, so that the operator can more easily drive the vehicle 10 so as to trace the virtual preceding vehicle 14, than in the case where the virtual preceding vehicle distance DSCCx is determined irrespective of the driving characteristics of the operator.

The present embodiment is also configured to display the image of the virtual preceding vehicle 14 on the front window 40 of the vehicle 10. Accordingly, the operator can visually recognize the image of the virtual preceding vehicle 14 as superimposed on a scene in front of the running vehicle 10. Thus, it is possible to display the image of the virtual preceding vehicle 14 such that the image can be easily visually recognized by the operator who is driving the vehicle 10.

The present embodiment is further configured such that when the vehicle 10 is presently running on the above-indicated once-running road whose information is included in the above-described running history 80, the running pattern of the virtual preceding vehicle 14 is generated on the basis of the running history 80, and the running state of the virtual preceding vehicle 14 is determined on the basis of the generated running pattern. Accordingly, the virtual preceding vehicle 14 exhibits a running behavior reflecting the driving characteristics of the operator, so that the displayed image of the virtual preceding vehicle 14 permits the operator can easily drive the vehicle 10 so as to trace the virtual preceding vehicle 14.

While the embodiment of the present invention has been described in detail by reference to the drawings, for illustrative purpose only it is to be understood that the invention may be embodied with various changes and improvements, which may occur to those skilled in the art.

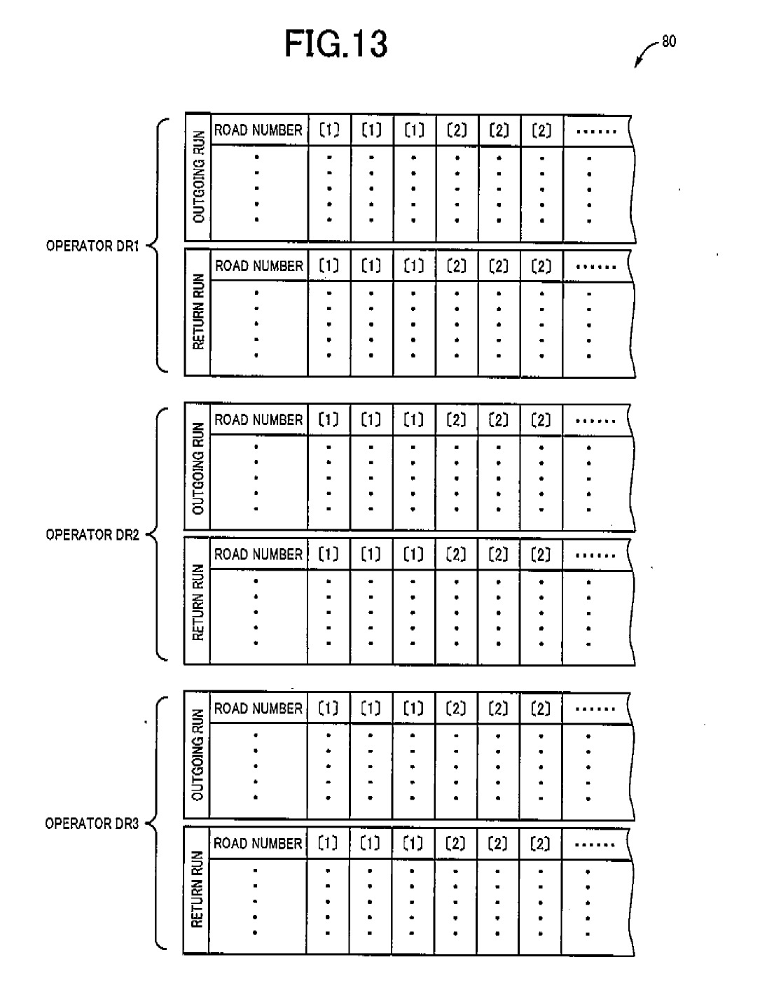

The illustrated embodiment is based on an assumption that the vehicle 10 is driven by a single operator whose running history (driving history) 80 is stored. However, the vehicle 10 may be driven by one of a plurality of operators. Where the vehicle 10 is driven by one of the plurality of operators, the electronic control device 12 is arranged to store the running history 80 (shown in FIG. 6) in the running history data base 52, for each of the individual operators, as indicated in FIG. 13 by way of example, so that the running state of the virtual preceding vehicle 14 is determined on the basis of the running history 80 corresponding to the operator who is presently driving the vehicle 10. In this case, any one of the individual operators who drives the vehicle 10 is unlikely to feel uneasy during driving of the vehicle 10 so as to trace the virtual preceding vehicle 14, and the driving burden on that operator can be effectively reduced. For instance, the specific operator who drives the vehicle 10 can be identified, by a weight sensor configured to measure the weight of the specific operator or a face recognizing sensor configured to recognize the face of the specific operator. Where the vehicle 10 is provided with a seat position memory device which permits an operator's seat to be placed in a selected one of a plurality of different positions stored in a memory, when a memory switch is operated by the specific operator to establish the selected seat position, the specific operator can be identified on the basis of an output signal of the memory switch. In the example of FIG. 13, three sets of the running history 80 for respective three operators DR1, DR2 and DR3 are stored in the running history data base 52. In the case where the running history 80 is stored for each of the plurality of operators as indicated in FIG. 13, the above-described virtual preceding vehicle distance map Lvds indicated in FIG. 7 and the above-described estimated operator's driving characteristics indicated in FIG. 9(b) are also generated and stored for each of the operators.

In the illustrated embodiment, the three estimated operator's driving characteristics Lca, Lcb and Lcc are provided as indicated in FIG. 9(b). However, only one estimated operator's driving characteristic may be provided, or two, four or more estimated operator's driving characteristics may be provided. While each of the illustrated, estimated operator's driving characteristics Lca, Lcb and Lcc represents a relationship between the radius of turning and running speed V of the vehicle 10, the estimated operator's driving characteristics may represent any other relationship, for instance, a relationship between the road width and the vehicle running speed V, a relationship between the acceleration value and radius of turning of the vehicle, or a relationship among the radius of turning of the vehicle, road width and vehicle running speed V. Where the parameters of the estimated operator's driving characteristics include the above-indicated, road width, the road width is included in the above-described vehicle-running-related information used to determine the above-indicated provisional running state of the virtual preceding vehicle 14, that is, in the information on the road, on which the virtual preceding vehicle 14 is to virtually run. Namely, the road information used to determine the above-indicated provisional running state of the virtual preceding vehicle 14 is not limited to the radius of curvature of the road used in the illustrated embodiment.

Although the running speed V and radius of turning of the vehicle 10 have been described as the above-indicated vehicle-running-related information used to obtain the above-indicated estimated operator's driving characteristics, for illustrative purpose only, with respect to the illustrated embodiment, any other quantity of state (e.g., yaw rate and acceleration value) may be used as the vehicle-running-related information used to obtain the above-indicated estimated operator's driving characteristics.

In the example of FIG. 9 in the illustrated embodiment, the estimated operator's driving characteristic Lcb is selected on the basis of the point PC1 representative of the radius of turning and running speed. V of the vehicle 10. If the point representative of the radius of turning and running speed V of the vehicle 10 is located intermediate between the lines of the estimated operator's driving characteristics Lca and Lcb, for example, the line of the estimated operator's driving characteristic passing the point representative of those radius of turning and running speed V is generated by interpolation with the lines of the estimated operator's driving characteristics Lca and Lcb, and the estimated operator's driving characteristic thus generated by interpolation can be used to determine the provisional running state of the virtual preceding vehicle 14.

In the illustrated embodiment, the vehicle running speed V is used as the parameter used to determine the running state of the virtual preceding vehicle 14. However, the vehicle running speed V may be replaced by any other parameter. Where the road on which the virtual preceding vehicle 14 is to virtually run is curved, the radius of turning of the virtual preceding vehicle 14 is determined to be equal to the radius of curvature of the road which is stored in the map data base 50, so that the virtual preceding vehicle 14 is to be virtually turned with the determined radius of turning.

While the illustrated embodiment uses the two options of the tendency of driving of the operator in the form of the tendency of driving for the relatively high degree of vehicle drivability and the tendency of driving for the relatively high degree of vehicle fuel economy, any other option may be provided. Further, only one option, for instance, the tendency of driving of the operator for the relatively high degree of vehicle fuel economy, may be provided.

In the illustrated embodiment, the running state optimizing portion 68 is configured to determine the tendency of driving of the operator depending upon whether the sporty drive mode selector switch is placed in the on state or off state. However, the tendency of driving of the operator may be determined depending upon a rate of change of the accelerator pedal operation amount Acc, rather than the on-off state of the sporty drive mode selector switch. For instance, the running state optimizing portion 68 can determine that the tendency of driving of the operator for the relatively high degree of vehicle drivability is selected, if the rate of change of the accelerator pedal operation amount Acc is equal to or higher than a predetermined threshold value, and determine that the tendency of driving of the operator for the relatively high degree of vehicle fuel economy is selected, if the rate of change of the accelerator pedal operation amount Acc is lower than the threshold value.

In the illustrated embodiment, the running state of the virtual preceding vehicle 14 is determined on the basis of the running pattern of the virtual preceding vehicle 14 (virtual running pattern) as indicated in FIG. 10. When the running state of the vehicle 10 at its present location considerably deviates from the running pattern, it is possible to inhibit the determination of the running state of the virtual preceding vehicle 14 and the displaying of the image of the virtual preceding vehicle 14. This inhibition is implemented for the fail-safe purpose. For instance, the running state of the vehicle 10 at its present location is considered to considerably deviate from the running pattern, if the running speed V of the vehicle 10 at its present location deviates from the running speed V obtained from the running pattern, by more than a predetermined amount.

Although the running state of the virtual preceding vehicle 14 is determined on the basis of the running pattern of the virtual preceding vehicle 14 (virtual running pattern) as indicated in FIG. 10 in the illustrated embodiment, the running state may be determined by any other method, without generation of the virtual running pattern.

The illustrated embodiment uses the running history (driving history) 80 as indicated in FIG. 6. The relationship (actual distance-running speed relationship point Pvds) as indicated in FIG. 7 between the vehicle-to-vehicle distance DSCC between the vehicle 10 and the actual preceding vehicle, and the running speed V of the vehicle 10 as well as the vehicle-running-related information based on which the estimated operator's driving characteristics as shown in FIG. 9(b) are determined, is data (information) obtained during the past running of the vehicle 10. In this respect, not only the running history 80 of FIG. 6, but also the above-indicated relationship may be considered to be included in the running history of the vehicle 10 (driving history of the operator), in a broad interpretation of the running history (driving history).

In SA8 of FIG. 11 in the illustrated embodiment, the running state of the virtual preceding vehicle 14 is optimized depending upon the tendency of driving of the operator. However, this optimization is not essential. For instance, the running state of the virtual preceding vehicle 14 whose image is displayed on the front window 40 may be determined according to the above-indicated virtual running pattern as generated in SA5, or may be the above-indicated provisional running state determined in SA7.

Further, SA6 and SA7 in the flow chart of FIG. 11 in the illustrated embodiment may be eliminated. In this case, it is possible to inhibit the determination of the running state of the virtual preceding vehicle 14, and the displaying of the image of the virtual preceding vehicle 14, if the negative determination is obtained in SA4. In the absence of the above-indicated SA6 and SA7, SB3 in FIG. 12 is eliminated.

In the illustrated embodiment, the virtual preceding vehicle distance DSCCx between the vehicle 10 and the virtual preceding vehicle 14 is determined according to the virtual preceding vehicle distance map Lvds indicated in FIG. 7. However, the virtual preceding vehicle distance DSCCx need not be determined according to the virtual preceding vehicle distance map Lvds, and may be a predetermined constant value, or a distance of running of the vehicle 10 at the present running speed V for a predetermined length of time. In this case, the above-indicated virtual preceding vehicle distance map Lvds is not necessary.

Although the image of the virtual preceding vehicle 14 is displayed on the front window 40 in the illustrated embodiment, the image need not be displayed on the front window 40. For instance, the image of the virtual preceding vehicle 14 may be displayed on a part of glasses worn by the operator.

In the illustrated embodiment, the above-indicated road information such as the lengths, radii of curvature, etc. of the roads is stored in the map data base 50, and is retrieved from the map data base 50. However, the road information may be obtained otherwise. Where the road information on the road on which the vehicle 10 is running is detected by sensors and stored in a storage concurrently with the storage of the running history 80, the road information on the road where the vehicle is running is available from its storage if the vehicle 10 is running on the once-running road.

In the illustrated embodiment, the running pattern of the virtual preceding vehicle 14 is shown in FIGS. 8 and 10, in relation to changes of the running speed V, accelerator pedal operation amount Acc and brake operation amount BRK. The running pattern of the virtual preceding vehicle 14 may include other parameters such as the gradient of the road, the band of running time of the day, and the on-off state of an air conditioner.

### NOMENCLATURE OF REFERENCE SIGNS

10: Vehicle
12: Electronic control device (Vehicle operator assisting apparatus)
14: Virtual preceding vehicle
40: Front window
80: Running history (Driving History)
DSCC: Vehicle-to-vehicle distance
DSCCx: Virtual preceding vehicle distance

1. A vehicle operator assisting apparatus configured to assist an operator of an own vehicle by displaying an image of a virtual preceding vehicle as if the virtual preceding vehicle was running in front of said own vehicle in a running state, such that the image is visually recognizable by the operator of the own vehicle, comprising:
a history data base which stores a driving history of said operator of said own vehicle;
a virtual preceding vehicle control portion configured to determine a running state of said virtual preceding vehicle on the basis of said driving history; and
a history generating portion configured to generate a relationship between a distance between said own vehicle in the running state and an actual preceding vehicle, and a running speed of said own vehicle, and store the generated relationship in said history database.
Wherein said virtual preceding vehicle control portion includes a driving characteristics extracting portion configured to determine a distance between said own vehicle and said virtual preceding vehicle on the basis of said stored relationship between the distance and the running speed.

2. The vehicle operator assisting apparatus according to claim 1, wherein said driving characteristics extracting portion determines, when said own vehicle is running on a road whose information is not included in said driving history, the running state of said virtual preceding vehicle according to driving characteristics of said operator estimated on the basis of information relating to running of said own vehicle, and on the basis of information on the road on which said virtual preceding vehicle is to virtually run.

3. The vehicle operator assisting apparatus according to claim 1, wherein said virtual preceding vehicle control portion includes a running state optimizing portion configured to change the running state of said virtual preceding vehicle depending upon a selected one of a plurality of predetermined different tendencies of driving of said operator.

4. (canceled)

5. The vehicle operator assisting apparatus according to claim 1, further comprising a display device configured to display the image of said virtual preceding vehicle on a front window of said own vehicle.
